(19) United States
(12) Patent Application Publication
(10) Pub. No.: US 2022/0186389 A1
(43) Pub. Date: Jun. 16, 2022

(54) HIGH-EFFICIENCY VANADIUM NITRIDE/MOLYBDENUM CARBIDE HETEROJUNCTION HYDROGEN PRODUCTION ELECTROCATALYST, AND PREPARATION METHOD AND APPLICATION THEREOF

(71) Applicant: SHAANXI UNIVERSITY OF SCIENCE & TECHNOLOGY, Xi' an (CN)

(72) Inventors: Jianfeng HUANG, Xi' an (CN); Shuainan LI, Xi' an (CN); Liangliang FENG, Xi' an (CN); Liyun CAO, Xi' an (CN); Yongqiang FENG, Xi' an (CN); Danyang HE, Xi' an (CN); Li FENG, Xi' an (CN); Xiao ZHANG, Xi' an (CN)

(21) Appl. No.: 17/643,571

(22) Filed: Dec. 9, 2021

(30) Foreign Application Priority Data
Dec. 15, 2020 (CN) 202011480813.7

(51) Int. Cl. C25B 11/091; C25B 1/04; C25B 11/067

(52) U.S. Cl. CPC C25B 11/091; C25B 11/067; C25B 1/04

(57) ABSTRACT

Provided is a high-efficiency vanadium nitride/molybdenum carbide heterojunction hydrogen production electrocatalyst, and a preparation method and application thereof. The electrocatalyst has a heterojunction structure formed by coupling VN and Mo₂C, wherein the mass ratio of VN and Mo₂C is 20:1 to 50:1. The electrocatalyst couples nano-VN and Mo₂C to form a VN/Mo₂C heterojunction, so that the active center is increased, and the balance of the reaction kinetics of H⁺ adsorption and H₂ desorption is facilitated, thereby greatly improving the activity of the electrocatalyst.

### TECHNICAL FIELD

The present disclosure belongs to the field of nano-powder catalytic materials, specifically relates to a high-efficiency vanadium nitride/molybdenum carbide heterojunction hydrogen production electrocatalyst, and a preparation method and application thereof.

### BACKGROUND

With the increasing prominence of fossil energy problems, people face a new round of opportunities and challenges. As a green, recyclable, and abundant resource, hydrogen energy has attracted more and more attention from scholars. Although platinum group metals (PGMs) have excellent catalytic performance, the platinum-based catalysts have disadvantages of high price, low content, and instability, etc. which seriously hinder their global application. The key technical point of hydrogen production by water splitting is to search for an excellent hydrogen production catalyst.

In recent years, researchers have discovered some important non-noble metal catalysts, such as transition metal carbides (TMCs) and transition metal nitrides (TMNs). Among them, TMCs mainly include molybdenum carbide (Mo₂C), nickel carbide (Ni₃C), tungsten carbide (WC and W₂C), vanadium carbide (VC), etc. TMNs mainly include vanadium nitride (VN), titanium nitride (TiN), zirconium nitride (ZrN) and niobium nitride (NbN). The above-mentioned non-noble metal catalysts have an electronic structure similar to Pt, which has attracted widespread attention from researchers. However, the hydrogen evolution reaction (HER) properties of single-phase TMCs or TMNs are limited by the lack of electronic structure and mismatch of hydrogen binding energy. In this regard, researchers have taken a series of measures to improve the HER performance of TMC or TMN catalysts, such as introducing carbon materials with certain morphologies, such as carbon nanotubes or graphene, to induce the carbonized growth of the materials and the synthesis of metal oxides of specific morphologies, or hybridize TMCs and TMNs to promote synergistic effects.

Among the above-mentioned non-noble metal catalysts, vanadium nitride has good electrical conductivity, thermal conductivity, and catalytic performance, and has a strong auxiliary effect on the desorption of H₂, but its synthesis temperature is relatively high and its morphology is difficult to control; molybdenum carbide has excellent catalytic performance and hydrogen binding energy, which is conducive to the adsorption of H+, but has poor conductivity, so that the electron transport rate on the electrode is influenced.

### SUMMARY

In view of this, the present disclosure aims to provide a high-efficiency VN/Mo₂C heterojunction hydrogen production electrocatalyst, and a preparation method and application thereof. The electrocatalyst couples nano-VN and Mo₂C to form a VN/Mo₂C heterojunction, so that the active center is increased, and the balance of the reaction kinetics of H⁺ adsorption and H₂ desorption is facilitated, thereby greatly improving the activity of the electrocatalyst.

In a first aspect, the present disclosure provides a VN/Mo₂C heterojunction hydrogen production electrocatalyst. The high-efficiency VN/Mo₂C heterojunction hydrogen production electrocatalyst has a heterojunction structure formed by coupling VN and Mo₂C. The heterojunction structure forms more defects and provides more active sites, so that the catalytic synergistic effect of VN and Mo₂C is promoted, and the catalytic performance is further improved.

Preferably, the high-efficiency VN/Mo₂C heterojunction hydrogen production electrocatalyst is in a coralline morphology formed by uniform distribution of VN particles and Mo₂C particles.

Preferably, the VN particles and Mo₂C particles have particle diameters of 30 to 100 nm and 50 to 100 nm, respectively.

In a second aspect, the present disclosure provides a preparation method of the high-efficiency VN/Mo₂C heterojunction hydrogen production electrocatalyst described in any one of the above aspects. The preparation method comprises the following steps: weighing and mixing raw materials including a carbon-nitrogen homologous compound, a vanadium source, and a molybdenum source, and maintaining heat at 400 to 500° C. under an inert atmosphere for 50 to 200 minutes, and maintaining heat at 700 to 900° C. for 120 to 180 minutes to obtain the VN/Mo₂C heterojunction hydrogen production electrocatalyst. Preferably, the temperature is maintained at 400 to 500° C. for 120 minutes.

Preferably, the mass ratio of the carbon-nitrogen homologous compound, the vanadium source, and the molybdenum source is (18 to 20):(3 to 5):(1 to 3).

Preferably, the mass percentage of nitrogen in the carbon-nitrogen homologous compound is more than 30%. The carbon-nitrogen homologous compound contains more than 30% of nitrogen by mass, and the higher the nitrogen content is, the more active sites are exposed, so that the combination of H⁺ during the electrolysis process of water is facilitated, and the release of H₂ is promoted. The mass percentage of nitrogen in the carbon-nitrogen homologous compound is more preferably 40 to 70%.

Preferably, the carbon-nitrogen homologous compound is pyrolyzed to generate reducing gas during the maintaining of heat and each composition of the VN/Mo₂C heterojunction hydrogen production electrocatalyst is uniformly dispersed. In some embodiments, the reducing gas is NH₃. This avoids the waste of resources and the increase of cost caused by the additional introduction of reducing gas during the preparation process.

Preferably, the carbon-nitrogen homologous compound is selected from at least one of ammonium dicyandiamide, melamine, and urea.

Preferably, the vanadium source is selected from vanadium acetylacetonate and/or ammonium metavanadate; and the molybdenum source is selected from ammonium molybdate tetrahydrate and/or sodium molybdate dihydrate. It is to be understood that the vanadium source and the molybdenum source used in the preparation method of the present disclosure include but are not limited to the above-mentioned compounds. Any form of compound that provides the elements vanadium and molybdenum may be used in the present disclosure. In practical applications, vanadium sources and molybdenum sources which are low in cost and good in practicability are preferably used. If used herein, the phrase “and/or” means any or all of multiple stated possibilities.

In a third aspect, the present disclosure further provides an application of the VN/Mo₂C heterojunction hydrogen production electrocatalyst described in any one of the above aspects in hydrogen production by water electrolysis.

The present disclosure has the following beneficial effects:

1. The VN/Mo₂C electrocatalyst of the present disclosure uses transition metal carbides and nitrides to form a heterojunction structure. Nitride provides good conductivity and has a lower reaction barrier of H₂; the carbide provides more active sites, which is beneficial to the adsorption of H⁺. The successful combination of the two balances the reaction kinetics of H⁺ adsorption and H₂ desorption and promotes a synergistic catalytic effect.

2. The preparation method of VN/Mo₂C by a solid phase method provides a new synthesis strategy for the hybridization of carbides and nitrides, has the advantages of a simple and easy operation, easy control, and suitability for industrial production.

3. The VN/Mo₂C electrocatalyst of the present disclosure can be applied to a full pH solution for producing hydrogen production by water splitting in the field of electrocatalysis, has a wide range of applications, and can meet the needs of industrial-scale production.

4. The electrocatalyst of the present disclosure has the characteristic of small overpotential (for example, the overpotential in alkaline, acidic, and neutral environments is 50 mV, 140 mV, and 185 mV, respectively, when the current is 10 mA/cm²), has good stability and a low Tafel slope, and has great potential for application in water splitting.

### BRIEF DESCRIPTION OF THE DRAWINGS

FIG. 1 shows an X-ray diffraction (XRD) pattern of the nano-VN/Mo₂C prepared in Example 1;

FIG. 2 shows a scanning electron microscope (SEM) image of the nano-VN/Mo₂C prepared in Example 1;

FIG. 3 shows a transmission electron microscopy (TEM) image of the nano-VN/Mo₂C prepared in Example 1;

FIG. 4 shows a graph of the hydrogen production performance of nano-VN/Mo₂C prepared in Example 2 under the condition of pH 14;

FIG. 5 shows a graph of the hydrogen production performance of nano-VN/Mo₂C prepared in Example 3 under the condition of pH 14;

FIG. 6 shows a graph of the hydrogen production performance of nano-VN/Mo₂C prepared in Example 4 under the condition of pH 14;

FIG. 7 shows a graph of the hydrogen production performance of nano-VN/Mo₂C prepared in Example 1 under the condition of pH 0;

FIG. 8 shows a graph of the hydrogen production performance of nano-VN/Mo₂C prepared in Example 1 under the condition of pH 14;

FIG. 9 shows a graph of the hydrogen production performance of nano-VN/Mo₂C prepared in Example 1 under the condition of pH 7;

FIG. 10 shows the XRD pattern of the nano-VN/Mo₂C prepared in Comparative Example 1;

FIG. 11 shows a graph of the hydrogen production performance of nano-VN/Mo₂C prepared in Comparative Example 1 under the condition of pH 14;

FIG. 12 shows a graph of the hydrogen production performance of a composite material in which VN and Mo₂C are physically mixed in Comparative Example 2 under the condition of pH 14;

FIG. 13 shows an X-ray photoelectron spectrogram of the nano-VN/Mo₂C prepared in Example 1;

FIG. 14 shows an XRD pattern of a sample prepared in Comparative Example 3;

FIG. 15 shows a TEM image of a sample prepared in Comparative Example 3 under different fields of view;

FIG. 16 shows a graph of the hydrogen production performance of a sample prepared in Comparative Example 3 under the condition of pH 14;

### DETAILED DESCRIPTION

The present disclosure will be further described below through the following embodiments. It should be understood that the following embodiments are only used to illustrate the present disclosure, not to limit the present disclosure.

The following exemplifies a preparation method of the high-efficiency VN/Mo₂C heterojunction hydrogen production electrocatalyst (also referred to as “VN/Mo₂C heterojunction nanopowder with electrocatalysis function”) of the present disclosure.

A carbon-nitrogen homologous compound, a vanadium source, and a molybdenum source are weighed according to a certain mass ratio. The mass ratio of the carbon-nitrogen homologous compound, the vanadium source, and the molybdenum source may be (18 to 20):(3 to 5):(1 to 3). When the mass ratio of the carbon-nitrogen homologous compound, the vanadium source, and the molybdenum source is out of the above range, such as 17:3:1, the vanadium oxide cannot be completely reduced, and the composition of the final product contains more vanadium oxide and other impurity phases, so that the generation of VN is influenced.

In the preparation method of the present disclosure, carbon and nitrogen elements are introduced by using the carbon-nitrogen homologous compound. The carbon-nitrogen homologous compound is pyrolyzed to produce a reducing gas (such as ammonia gas) in the subsequent reaction process, so that the reducing gas not only plays the role of a reducing agent, but also can realize the uniform dispersion of VN particles and Mo₂C particles in the composite structure and no additional reducing agent or dispersing agent is needed. In addition, the compound with carbon and nitrogen homologous compound is adopted, the types of compounds involved in the reaction are reduced, and aggregation, impurity introduction and impurity phase accumulation during the high-temperature carbonization process are avoided as much as possible. In addition, carbon-nitrogen homologous compound is inexpensive, suitable for industrial production, and safe in reaction.

Preferably, the mass percentage of nitrogen in the carbon-nitrogen homologous compound is more than 30%. During the experimental process, it was unexpectedly discovered that when the mass percentage of nitrogen in the homologue of a carbon source and a nitrogen source is higher, the yield of the produced product is high and the catalytic performance is excellent. For example, the inventors explored the influence of different nitrogen sources on the electrocatalytic performance of VN/Mo₂C catalysts. As a result, the product VN/Mo₂C electrocatalyst showed a heterojunction structure when the mass percentage of nitrogen in the carbon-nitrogen homologous compound reached more than 30%, although the products obtained by using different nitrogen sources had a small difference in phase and surface morphology. The heterojunction structure is beneficial to enhance the conduction of electrons and improve the catalytic performance. In some embodiments, the carbon-nitrogen homologous compound has a nitrogen content of 40 to 70% by mass. In specific embodiments, the carbon-nitrogen homologous compound includes, but is not limited to, one or more of dicyandiamide, melamine, and urea.

The weighed carbon-nitrogen homologous compound, the vanadium source and the molybdenum source are mixed to obtain a mixture, preferably by dry mixing. For example, the mixing may be carried out by means of stirring, ball milling, and the like. The mixing time is not limited, so that all the raw materials are uniformly mixed. The mixture is prepared by solid-phase synthesis to prepare the target product of VN/Mo₂C heterojunction hydrogen production electrocatalyst. The solid phase synthesis is carried out under an inert protective atmosphere. The inert protective atmosphere can be argon. Preferably, the flow rate of the inert protective atmosphere is 20 to 40 SCCM.

For example, the mixture is placed in an agate mortar, ground for 20 to 30 minutes, and then loaded into a porcelain boat. The porcelain boat is placed in a tubular atmosphere furnace, two furnace plugs are respectively placed at each end of the tube, and the furnace plugs are spaced by 5 cm. An inert atmosphere is introduced into the tubular atmosphere furnace, and then exhausting and supplementing air for 4 to 6 times, exhausting the air in the tubular atmosphere furnace, and not exhausting air after the last air supplement. The inert atmosphere can be argon. The solid phase synthesis is carried out in two stages. The first stage is as follows: the protective atmosphere is introduced at a flow rate of 20 to 40 SCCM, heating to 400 to 500° C. at a heating rate of 5 to 10° C./min, and maintaining the temperature at 400 to 500° C. for 120 minutes. The second stage is as follows: continuously heating to 700 to 900° C., and maintaining the temperature at 700 to 900° C. for 120 to 180 minutes. The above scheme adopts a sectional heating mechanism. The purpose of the first stage is to generate C₃N₄ by low-temperature pyrolysis, and the effect of the second stage is that C₃N₄ reduces V in the vanadium source and generates VN. As the temperature continues to rise, Mo⁶⁺ and Mo⁴⁺ are reduced to Mo²⁺ by the NH₃ produced during the pyrolysis process, and then react with C to generate Mo—C, and further form a VN/Mo₂C heterojunction structure. After the continuous heating is finished, the mixture is cooled to room temperature along with the furnace, and the black sample is ground to obtain the VN/Mo₂C heterojunction hydrogen production electrocatalyst. Compared with VN and Mo₂C which are physically mixed, the performance of the physical composite sample is far inferior to that of the VN/Mo₂C heterojunction sample at the same current density, and the synergetic catalytic effect of the heterojunction structure on the electrocatalysis performance of the sample is highlighted.

The VN/Mo₂C heterojunction nanopowder of the present disclosure has uniform morphology and size, good conductivity and good stability, and can be applied to electrocatalysis of a full pH solution, and provides another green and abundant energy source for electrolytic water to replace a high-cost platinum-based material most widely applied in the industry at present.

In the high-efficiency VN/Mo₂C heterojunction hydrogen production electrocatalyst of the present disclosure, the mass ratio of VN and Mo₂C can be 20:1 to 50:1. This mass ratio is obtained by Inductively Coupled Plasma (ICP) test. The equipment used in the ICP test is Optima 7300V (PerkinElmer Company, USA). The ICP sample preparation is as follows: (i) 1 mg of the sample is weighed and dissolved in 20 mL of aqua regia (concentrated hydrochloric acid and concentrated nitric acid are prepared in a volume ratio of 3:1), and heated in an oil bath at 100° C. until the solution volatilizes to 1 mL; (ii) the volatilized solution is diluted into a 100 mL volumetric flask, the pH of the solution is adjusted to be a weak acidic (around pH 6), and filled in a 10 mL centrifuge tube; and (iii) the ppm concentration of vanadium ions and molybdenum ions (ppm represents the percentage of the solute in the mass of the solution) is tested, so that the mass ratio of VN and Mo₂C can be calculated.

The electrocatalytic hydrogen evolution test adopts a three-electrodes system, and is carried out on a CHI660E B 17060 electrochemical workstation (Shanghai Chenhua Instrument Co., Ltd.), the used reference electrode is a saturated calomel electrode (SCE), and the counter electrode is a graphite carbon rod, the working electrode is a glassy carbon electrode. The steps of preparing the working electrode are as follows: (i) 10 mg of catalyst is dispersed in isopropanol (200 μL) and ultrasonicated to form a uniform mixture; (ii) 2 μL of the mixture solution is dropped onto the glassy carbon electrode (GCE), the loading density of the catalyst is about 1.4 mg/cm²; and (iii) after the catalyst is naturally air-dried in the air, in order to prevent the catalyst from falling off due to the influence of the electrolyte during the measurement process, 2 μL of 1% Nafion (binder) solution should be applied to the surface of the catalyst that has been dried. The prepared samples are tested for electrocatalytic performance under acidic (0.5 M H₂SO₄), neutral (pH 7 phosphate buffer solution), and alkaline (1 M KOH) conditions. The linear sweep voltampere (LSV) curve is tested at a sweep rate of 3 mV s⁻¹.

Hereinafter, the present disclosure will be further described with the following examples. It should be understood that the following examples are used to explain this disclosure and do not mean to limit the scope of this disclosure. Any non-essential improvements and modifications made by a person skilled in the art based on this disclosure all fall into the protection scope of this disclosure. The specific process parameters below are only exemplary, and a person skilled in the art can choose proper values within an appropriate range according to the description, and are not restricted to the specific values shown below.

### EXAMPLE 1

1) Melamine, ammonium metavanadate, and ammonium molybdate tetrahydrate were weighed according to the mass ratio of 19:5:3.

2) The above powders were dry mixed and ground in an agate mortar for 30 minutes, then put into a porcelain boat and the porcelain boat was placed in a tubular atmosphere furnace with two plugs by 5 cm apart at each end of the tube.

3) Argon gas was introduced into the tube, and then air extraction and supplementation were performed 6 times. After exhausting the air in the tube, no more air extraction was performed after the last air supplementation. An inert protective atmosphere (argon) was introduced at a flow rate of 40 SCCM, and was heated at a rate of 10° C./min to 500° C. which was maintained at 500° C. for 120 minutes, then was heated to 800° C. which was maintained for 180 minutes.

4) After the continuous heating was over, the black sample was cooled down to room temperature and ground to obtain the target product VN/Mo₂C.

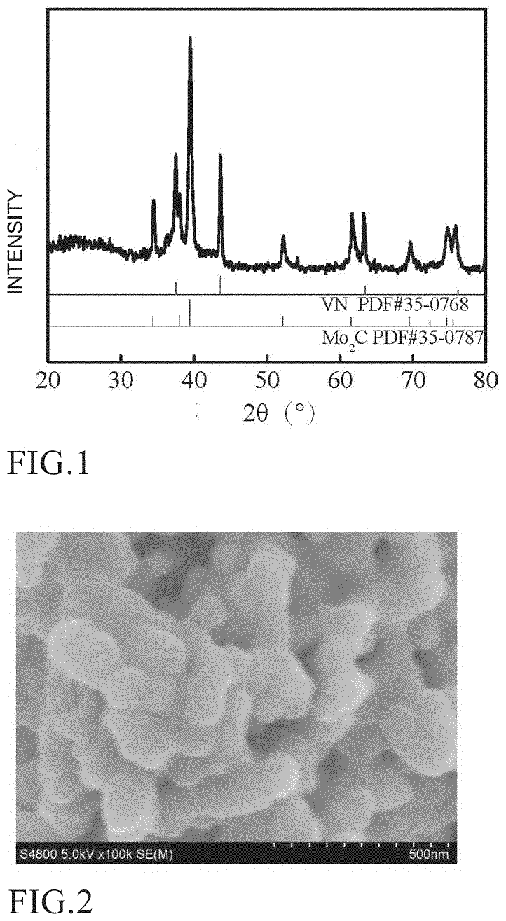

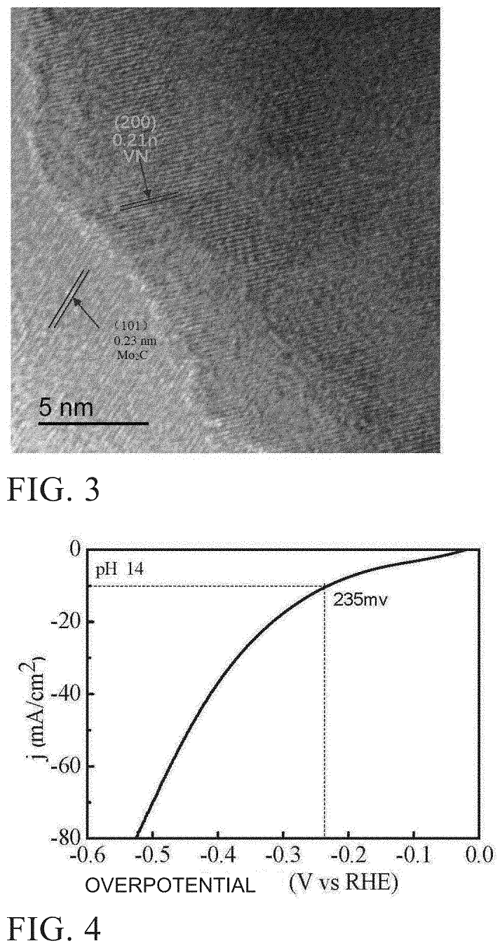

FIG. 1 shows an X-ray diffraction (XRD) pattern of the nano-VN/Mo₂C prepared in Example 1, it can be seen that the diffraction peaks of VN and Mo₂C are well matched with the standard card, and the intensity is high, indicating that the crystallinity of VN/Mo₂C is very good. FIG. 2 shows a scanning electron microscope (SEM) image of the nano-VN/Mo₂C prepared in Example 1, it can be seen that the morphology of the sample is a polyp-like structure, and the sample has a good dispersion. FIG. 3 shows a transmission electron microscopy (TEM) image of the nano-VN/Mo₂C prepared in Example 1, it can be seen that VN/Mo₂C has an obvious heterojunction structure, and the lattice fringes of 0.21 nm correspond to the (200) crystal plane of VN and the lattice fringes of 0.23 nm correspond to the (101) crystal plane of Mo₂C.

FIG. 13 shows an X-ray photoelectron spectrogram of the nano-VN/Mo₂C prepared in Example 1, it can be seen that the VN particles and Mo₂C particles are uniformly distributed.

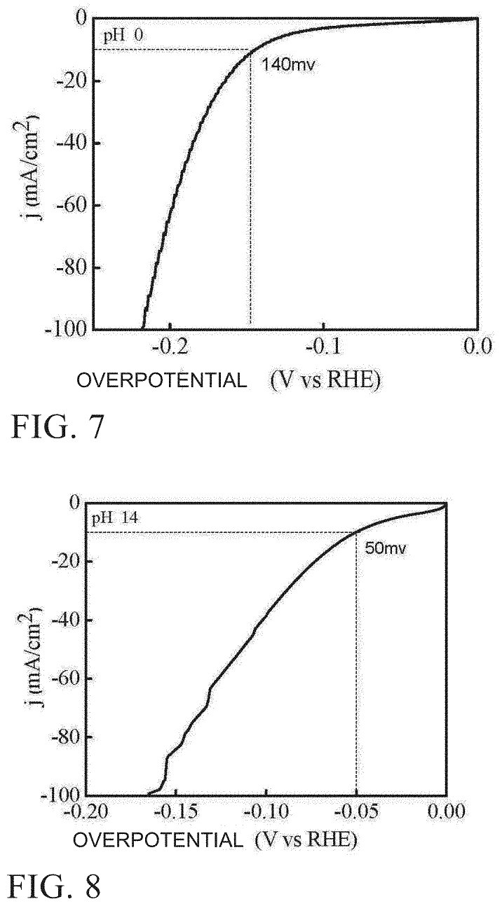

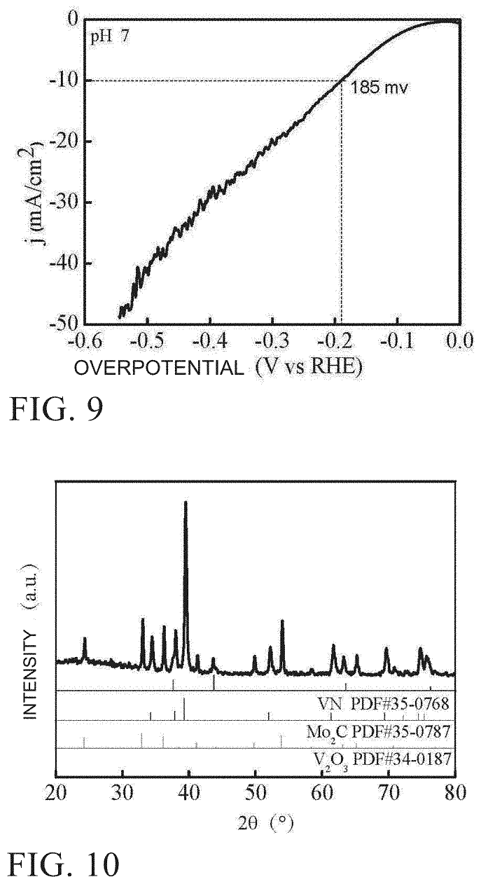

FIG. 7 shows a graph of the hydrogen production performance of the nano-VN/Mo₂C prepared in Example 1 under the condition of pH 0, the overpotential of the sample is 140 mV when the current density is 10 mA/cm² and the scan rate is 3 mV/s. FIG. 8 shows a graph of hydrogen production performance of nano-VN/Mo₂C prepared in Example 1 under the condition of pH 14. The overpotential of the sample is 50 mV when the current density is 10 mA/cm² and the scan rate is 3 mV/s. FIG. 9 shows a hydrogen production performance graph of the nano-VN/Mo₂C prepared in Example 1 under the condition of pH 7, the overpotential of the sample is 185 mV when the current density is 10 mA/cm² and the scan rate is 3 mV/s. The above illustrates that the VN/Mo₂C heterojunction hydrogen production electrocatalyst prepared in Example 1 has excellent hydrogen production performance in a full pH solution.

### EXAMPLE 2

1) Urea, ammonium metavanadate, and ammonium molybdate tetrahydrate were weighed according to the mass ratio of 18:3:1.

2) The above powders were dry mixed and ground in an agate mortar for 20 minutes, then put into a porcelain boat and the porcelain boat was placed in a tubular atmosphere furnace with two plugs 5 cm apart at each end of the tube.

3) Argon gas was introduced into the tube, and then air extraction and supplementation were performed 4 times. After exhausting the air in the tube, no more air extraction was performed after the last air supplementation. An inert protective atmosphere (argon) was introduced at a flow rate of 20 SCCM, and was heated at a rate of 5° C./min to 400° C. which was maintained at 400° C. for 120 minutes, then was heated to 700° C. which was maintained for 120 minutes.

4) After the continuous heating was over, the black sampled was cooled down to room temperature and ground to obtain the target product VN/Mo₂C.

FIG. 4 shows a graph of the hydrogen production performance of the nano-VN/Mo₂C prepared in Example 2 under the condition of pH 14, the overpotential of the sample is 235 mV when the current density is 10 mA/cm² and the scan rate is 3 mV/s, indicating excellent hydrogen production performance.

### EXAMPLE 3

1) Dicyanide, ammonium metavanadate, and ammonium molybdate tetrahydrate were weighed according to the mass ratio of 19:4:2.

2) The above powders were dry mixed and ground in an agate mortar for 30 minutes, then put into a porcelain boat and the porcelain boat was placed in a tubular atmosphere furnace with two plugs 5 cm apart at each end of the tube.

3) Argon gas was introduced into the tube, and then air extraction and supplementation were performed 5 times. After exhausting the air in the tube, no more air extraction was performed after the last air supplementation. An inert protective atmosphere (argon) was introduced at a flow rate of 30 SCCM, and was heated at a rate of 10° C./min to 500° C. which was maintained at 500° C. for 120 minutes, then was heated to 800° C. which was maintained for 180 minutes.

4) After the continuous heating was over, the black sample was cooled down to room temperature and ground to obtain the target product VN/Mo₂C.

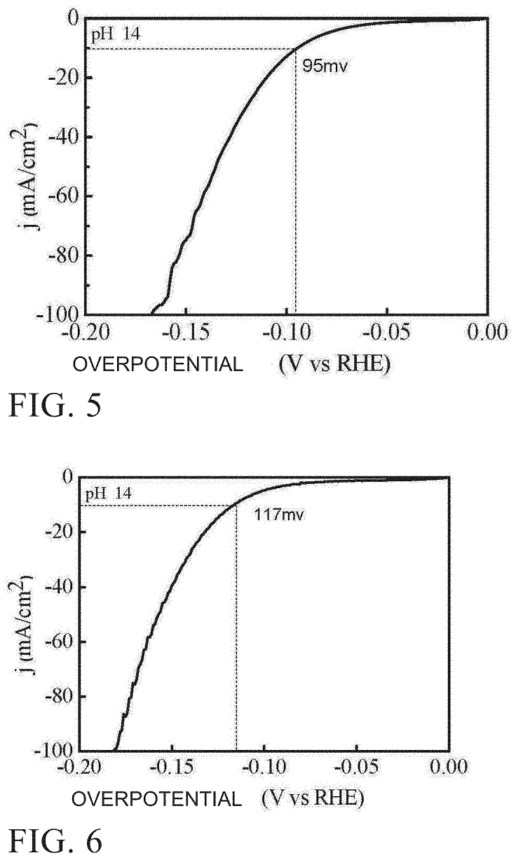

FIG. 5 shows a graph of the hydrogen production performance of the nano-VN/Mo₂C prepared in Example 3 under the condition of pH 14, the overpotential of the sample is 95 mV when the current density is 10 mA/cm² and the scan rate is 3 mV/s, indicating excellent hydrogen production performance.

### EXAMPLE 4

1) Melamine, ammonium metavanadate, and ammonium molybdate tetrahydrate were weighed according to the mass ratio of 20:3:1.

2) The above powders were dry mixed and ground in an agate mortar for 20 minutes, then put into a porcelain boat and the porcelain boat was placed in a tubular atmosphere furnace with two plugs 5 cm apart at each end of the tube.

3) Argon gas was introduced into the tube, and then air extraction and supplementation were performed 6 times. After exhausting the air in the tube, no more air extraction was performed after the last air supplementation. An inert protective atmosphere (argon) was introduced at a flow rate of 40 SCCM, and was heated at a rate of 5° C./min to 400° C. which was maintained at 400° C. for 120 minutes, then was heated to 900° C. which was maintained for 120 minutes.

4) After the continuous heating was over, the black sample was cooled down to room temperature and ground to obtain the target product VN/Mo₂C.

FIG. 6 shows a graph of the hydrogen production performance of the nano-VN/Mo₂C prepared in Example 4 under the condition of pH 14, the overpotential of the sample is 117 mV when the current density is 10 mA/cm² and the scan rate is 3 mV/s, indicating excellent hydrogen production performance.

### EXAMPLE 5

Example 5 is basically the same as Example 3, except that the mass ratio of urea, ammonium metavanadate, and ammonium molybdate tetrahydrate in step 1 was 19:4:2.

### EXAMPLE 6

Example 6 is basically the same as Example 2, except that the inert protective atmosphere (argon) was introduced at a flow rate of 30 SCCM.

### COMPARATIVE EXAMPLE 1

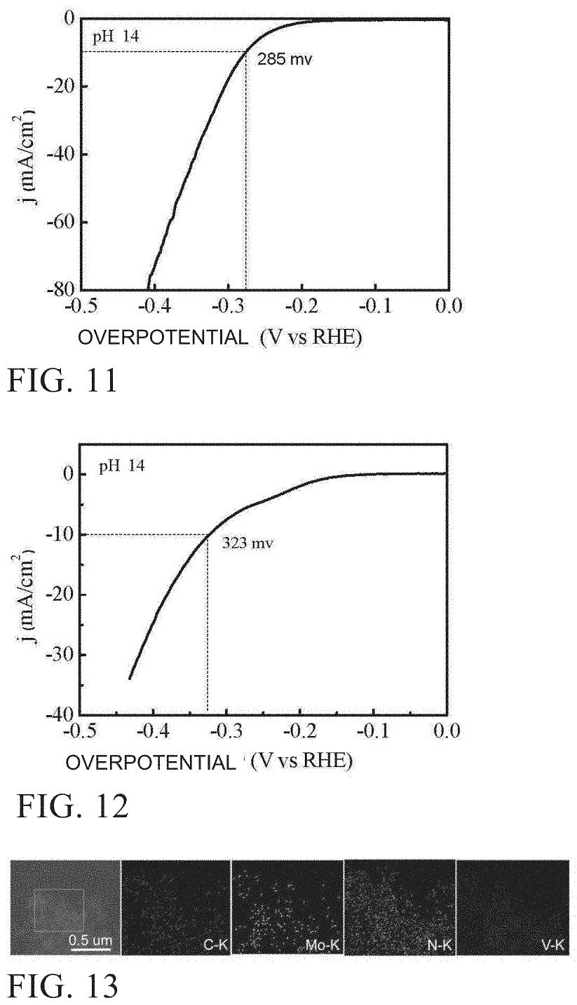

Comparative Example 1 is basically the same as Example 1, except that the mass ratio of urea, ammonium metavanadate, and ammonium molybdate tetrahydrate was 17:3:1. FIG. 10 shows the XRD pattern of the nano-VN/Mo₂C prepared in Comparative Example 1, it can be seen that VN has not been completely reduced, and there are vanadium trioxide peaks and many miscellaneous peaks. FIG. 11 shows the hydrogen production performance graph of nano-VN/Mo₂C prepared in Comparative Example 1 at pH 14, it can be seen that the overpotential of the sample is 285 mV more than 235 mV in FIG. 4 when the current density is 10 mA/cm² and the scan rate is 3 mV/s, indicating worse performance.

### COMPARATIVE EXAMPLE 2

The VN and Mo₂C (the molar ratio of V:Mo is 2:1) were stirred and physically mixed. FIG. 12 is the hydrogen production performance diagram of the composite material of Comparative Example 2 where VN and Mo₂C are physically mixed under the condition of pH 14, it can be seen that the performance of the physical mixed sample (323 mV) is not as good as that of VN/Mo₂C heterojunction samples (50 mV) under the same current density. It is further verified that the heterojunction structure can expose more active sites to form a larger electrochemical area, indicating better electrocatalytic performance.

### COMPARATIVE EXAMPLE 3

Comparative Example 3 is basically the same as Example 1, except that thiocyanuric acid was used as a carbon-nitrogen homologous compound (the nitrogen content is less than 30%).

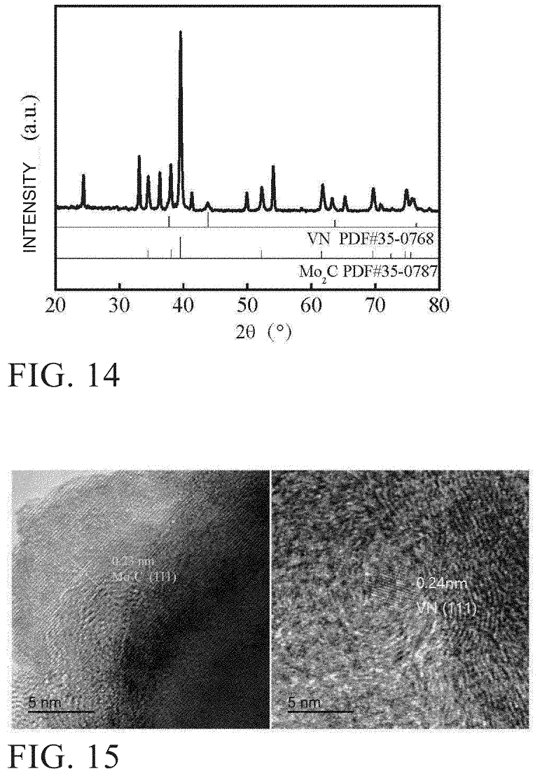

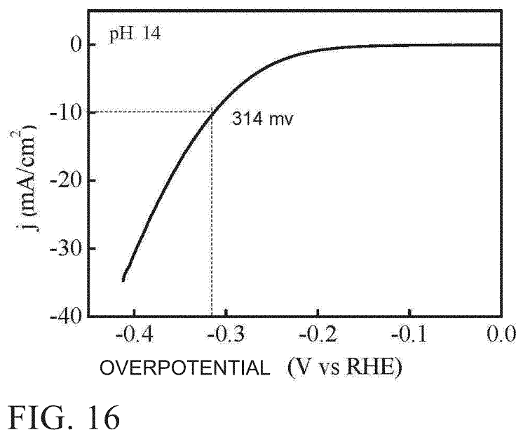

When the composite material is prepared with thiocyanuric acid, ammonium metavanadate, and ammonium molybdate tetrahydrate (the mass ratio of thiocyanuric acid:ammonium metavanadate:ammonium molybdate tetrahydrate was 19:5:3), the XRD of the sample is shown in FIG. 14, and it can be seen that diffraction peaks of VN and Mo₂C match well with the standard card, but the diffraction peak intensity of VN is very weak, indicating that the nitrogen content of carbon-nitrogen homologous compounds is below 30%, which is bad for the generation of VN. FIG. 15 shows a TEM image of the sample. VN and Mo₂C lattice fringes can be seen in different parts of the sample, and no heterojunction structure is found. Combining XRD and TEM analysis, it can be seen that when the nitrogen content of carbon-nitrogen homologous compounds is below 30%, the formation of VN is affected, and the heterojunction structure of VN and Mo₂C is not formed, which affects the catalytic performance of the sample. FIG. 16 shows the hydrogen production performance diagram of the sample, it can be seen from the figure that the sample overpotential is 314 mV, and greater than Example 1 (235 mV) when the current density is 10 mA/cm² and the scan rate is 3 mV/s under the test condition of pH 14, indicating that the performance is significantly worse.

1. A VN/Mo₂C heterojunction hydrogen production electrocatalyst, comprising:
a heterojunction structure formed by coupling VN and Mo₂C, wherein
the mass ratio of VN and Mo₂C is 20:1 to 50:1.

2. The VN/Mo₂C heterojunction hydrogen production electrocatalyst according to claim 1, wherein the electrocatalyst is in a coralline morphology formed by uniform distribution of VN particles and Mo₂C particles.

3. The VN/Mo₂C heterojunction hydrogen production electrocatalyst according to claim 2, wherein the VN particles and Mo₂C particles have particle diameters of 30 to 100 nm and 50 to 100 nm, respectively.

4. A preparation method of the VN/Mo₂C heterojunction hydrogen production electrocatalyst according to claim 1, wherein the preparation method comprises the following steps:
weighing and mixing raw materials including a carbon-nitrogen homologous compound, a vanadium source, and a molybdenum source, and
maintaining heat at 400 to 500° C. under an inert atmosphere for 50 to 200 minutes, and maintaining heat at 700 to 900° C. for 120 to 180 minutes to obtain the VN/Mo₂C heterojunction hydrogen production electrocatalyst.

5. The preparation method according to claim 4, wherein the mass ratio of the carbon-nitrogen homologous compound, the vanadium source, and the molybdenum source is (18 to 20):(3 to 5):(1 to 3).

6. The preparation method according to claim 4, wherein the carbon-nitrogen homologous compound contains more than 30% of nitrogen by mass.

7. The preparation method according to claim 6, wherein the carbon-nitrogen homologous compound contains 40 to 70% of nitrogen by mass.

8. The preparation method according to claim 4, wherein the carbon-nitrogen homologous compound is pyrolyzed to generate reducing gas during the maintaining of heat, and each composition of the VN/Mo₂C heterojunction hydrogen production electrocatalyst is uniformly dispersed.

9. The preparation method according to claim 4, wherein the carbon-nitrogen homologous compound is selected from at least one of ammonium dicyandiamide, melamine, and urea.

10. The preparation method according to claim 4, wherein
the vanadium source is selected from vanadium acetylacetonate and/or ammonium metavanadate; and
the molybdenum source is selected from ammonium molybdate tetrahydrate and/or sodium molybdate dihydrate.

11. An application of the VN/Mo₂C heterojunction hydrogen production electrocatalyst according to claim 1 in hydrogen production by water electrolysis under a full pH solution environment.
